(19) United States
(12) Patent Application Publication
(10) Pub. No.: US 2016/0189539 A1
(43) Pub. Date: Jun. 30, 2016

(54) BATTERY-FREE SMART KEY

(71) Applicant: HON HAI PRECISION INDUSTRY CO., LTD., New Taipei (TW)

(72) Inventors: SHIANG-HUA LIN, New Taipei (TW); KUANG-YAO LIAO, New Taipei (TW); PING-MAO LEE, New Taipei (TW)

(21) Appl. No.: 14/791,916

(22) Filed: Jul. 6, 2015

(30) Foreign Application Priority Data
Dec. 31, 2014 (TW) 103146683

(51) Int. Cl. G08C 23/04; E05B 81/64; E05B 47/00; E05B 81/56; H04B 10/80; E05B 19/00

(52) U.S. Cl. CPC G08C 23/04; H04B 10/807; E05B 19/0082; E05B 47/00; E05B 81/56; E05B 81/64; E05B 2047/0088

(57) ABSTRACT

A battery-free smart key with infrared system (IR) comprises a receiving coil, a side controller, and an infrared data association (IRDA) communication transmitter (TX) module. The receiving coil is able to receive electromagnetic waves with a wireless power and a certification data transmitted from an outside system. The side controller is used for processing the certification data and distributing the wireless power transmitted from the receiving coil. The IRDA communication TX module is coupled to the side controller and is able to transmit an IRDA communication signal with at least one certain user information. When the security entry system receives the correct IRDA communication signal, a door or an entry system can be unlocked. A car entry with IR system combined therewith is also disclosed.

### FIELD

The subject matter herein generally relates to door security.

### BACKGROUND

As the advanced market of cars is maturing, more and more smart keys are developed combined with high technologies and various innovations. Such as radio frequency identification (RFID) systems integrated with keyless technology can be applied in car entry systems so that gradually replace transitional car keys, so that when a user is close to a car with the RFID keyless system, the car entry systems allow unlocking The RFID keyless system may comprise an authentication to identify a certification signal transmitted from an electronic device carried by users. Usually, the certification signal is encrypted, but that increases loading calculation, longer time for decrypting, and higher cost. For various functions, the electronic device carried by users is weighty and has large power consumption. Even smart phones can be used in car keyless system.

Even though RFID keyless or smart phones can be used in the smart keys, energy consumption is significant and personal data privacy and security must be considered.

### BRIEF DESCRIPTION OF THE DRAWINGS

Implementations of the present technology will now be described, by way of example only, with reference to the attached figures.

FIG. 1 illustrates a car entry with IR system according to the present embodiment.

FIG. 2 is a block diagram of the car entry with IR system of FIG. 1.

FIG. 3 is a block diagram of a security entry with infrared (IR) system according to the present embodiment.

FIG. 4 is a flow diagram illustrating a method for unlocking the doors of the car entry.

### DETAILED DESCRIPTION OF EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

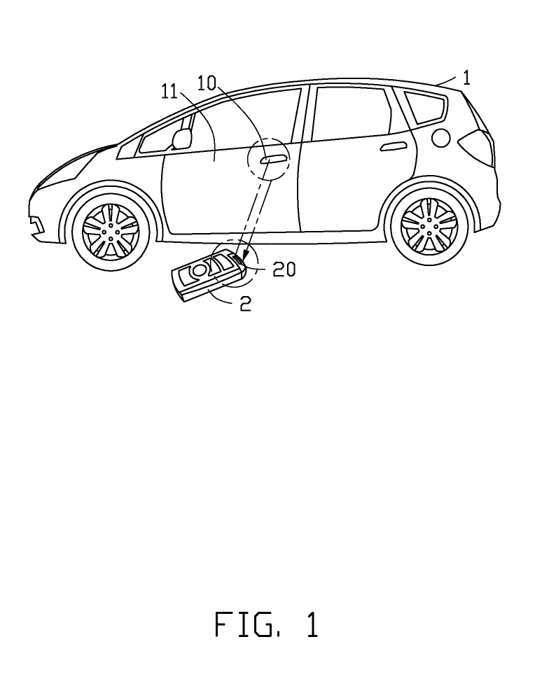

FIG. 1 illustrates a car entry with IR system 1 which comprises an infrared (IR) signal transmitter 10 and a battery-free smart key 2 having an infrared (IR) signal receiver 20.

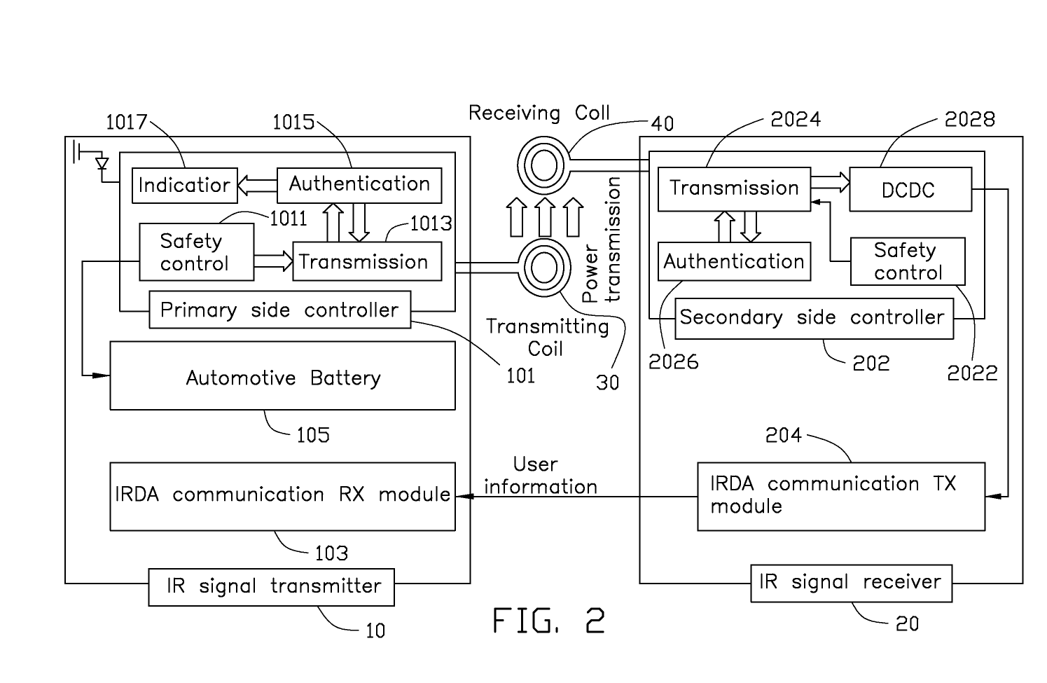

Referring to FIG. 2, the IR signal transmitter 10 is coupled to a transmitting coil 30 which is able to transmit electromagnetic waves in the IR spectrum. In one embodiment of the present disclosure, the electromagnetic waves comprise a wireless power and a certification signal that are transformed in the IR spectrum. The IR signal transmitter 10 comprises a primary side controller 101 and an infrared data association (IRDA) communication receiver (RX) module 103, wherein the primary side controller 101 is coupled to the transmitting coil 30. Regarding the transmitting coil 30, any IR transmitting device emitting wireless power and certification signal can be used.

In one embodiment of the present disclosure, an automotive battery 105 is coupled to the primary side controller 101 and provides power to the transmitting coil 30 under the control of the primary side controller 101. Further, the primary side controller 101 comprises a safety control 1011, a transmission 1013, an authentication 1015, and an indicator 1017, wherein the safety control 1011 is coupled to the automotive battery 105 for passing the power from the automotive battery 105. The transmission 1013 is coupled to the safety control 1011 and the authentication 1015 is coupled to the transmission 1013 to transmit the electromagnetic waves. The indicator 1017 is coupled to the authentication 1015. The IRDA communication RX module 103 is used for receiving an IRDA communication signal with at least one certain user information from the IRDA communication TX module 204. When the user information matches a stored user information inputted into the memory chip of the car entry, the correct user information will cause the doors 11 of the car entry to be unlocked.

The IRDA communication RX module 103 read a certification signal from IR signal transmitter 10

The IR signal receiver 20 is coupled to a receiving coil 40 for receiving the electromagnetic waves emitted from the transmitting coil 30. In one embodiment of the present disclosure, the efficient reception range within which the receiving coil 40 can receive the electromagnetic waves from the transmitting coil 30 is 20 meters. Regarding the receiving coil 40, any IR sensor which is able to receive wireless power and certification signal can be used.

The IR signal receiver 20 comprises a secondary side controller 202 and an infrared data association (IRDA) communication transmitter (TX) module 204, wherein the secondary side controller 202 is coupled to the receiving coil 40. The IRDA communication TX module 204 is used for transmitting the IRDA communication signal with the at least one certain user information. Further, the secondary side controller 202 comprises a second safety control 2022, a second transmission 2024 coupled to the second safety control 2022, a second authentication 2026 coupled to the second transmission 2024, and a DC-DC converter (DCDC) 2028 coupled to the second transmission 2024. The DCDC 2028 is coupled to the IRDA communication TX module 204. In one embodiment of the present disclosure, the second safety control 2022 is used for controlling the power distribution from the wireless power to the secondary side controller 2022 and the second authentication 2026 is used for certificating the certification signal from IR signal transmitter 10 then through the DCDC 2028 to control the IRDA communication TX module 204.

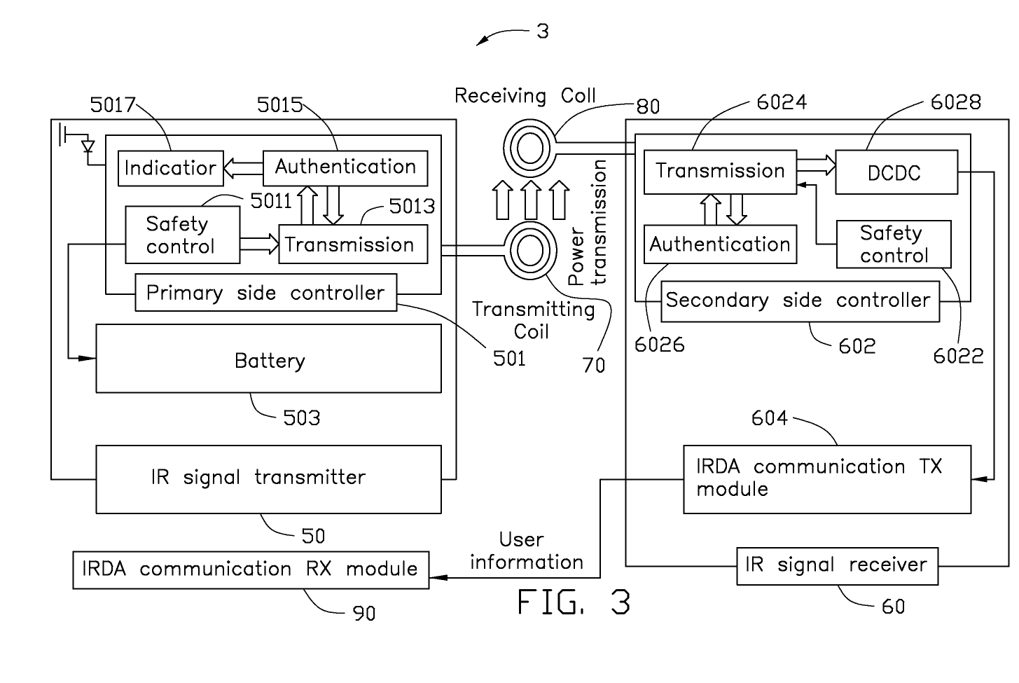

FIG. 3 illustrates a security entry with infrared (IR) system 3 which comprises an IR signal transmitter 50, an IR signal receiver 60, and an infrared data association (IRDA) communication receiver (RX) module 90. The IR signal transmitter 50 comprises a primary side controller 501. The IR signal receiver 60 comprises a secondary side controller 602 and an infrared data association (IRDA) communication transmitter (TX) module 604. The security entry with IR system 3 stores user's information that has been inputted into the IR signal receiver 60.

The primary side controller 501 is coupled to a transmitting coil 70 for transmitting electromagnetic waves in the IR spectrum, wherein the electromagnetic waves comprises a wireless power and a certification signal. Regarding the transmitting coil 70, any IR transmitting device emitting wireless power and certification signal can be used. In one embodiment of the present disclosure, a battery 503 is coupled to the primary side controller 501 for providing power.

The primary side controller 501 comprises a first safety control 5011, a first transmission 5013 coupled to the first safety control, a first authentication 5015 coupled to the first transmission 5213, and an indicator 5017 coupling to the first authentication 5015. The IRDA communication RX module 90 is used for receiving an IRDA communication signal with at least one certain user information whereby the security entry with IR system 3 will unlock entry system.

The secondary side controller 602 is coupled to a receiving coil 80 for receiving the electromagnetic waves. In one embodiment of the present disclosure, the secondary side controller 602 comprises a second safety control 6022, a second transmission 6024 coupled to the second safety control 6022, a second authentication 6026 coupled to the second transmission 6024, and a DC-DC converter (DCDC) 6028 coupled to the second transmission 6024. In one embodiment of the present disclosure, an efficient reception range for the receiving coil 80 to receive the electromagnetic waves from the transmitting coil 70 is 20 meters. Regarding the receiving coil 80, any IR sensor which is able of receiving wireless power and certification signal can be used.

The IRDA communication TX module 604 coupled to DCDC 6028 inside the secondary side controller 602 is used for transmitting an IRDA communication signal with at least one certain user information, whereby the IRDA communication RX module 90 is able to receive the IRDA communication signal to control the security entry with IR system 3 to unlock entry system. In one embodiment of the present disclosure, the second safety control 6022 is used for controlling the power distribution from the wireless power to the secondary side controller 602; the second authentication 6026 is used for certificating the certification signal from IR signal transmitter 50, then through the DCDC 6028 to control the IRDA communication TX module 604.

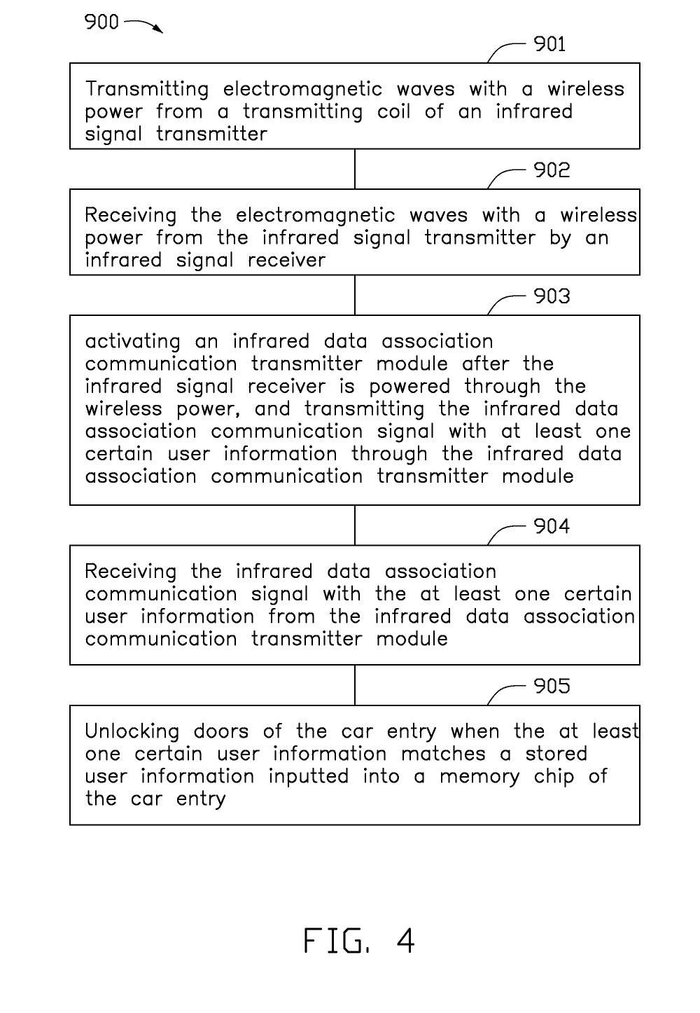

Referring to FIG. 4, a flowchart 900 is presented in accordance with an example embodiment which is being thus illustrated. The example method for controlling the car entry is provided by way of example, as there are a variety of ways to carry out the method. The method described below can be carried out using the configurations illustrated in FIG. 1 to FIG. 3, for example, and various elements of these figures are referenced in explaining example method. Each block shown in FIG. 4 represents one or more processes, methods or subroutines, carried out in the example method. Additionally, the illustrated order of blocks is by example only and the order of the blocks can change according to the present disclosure.

In Block 901, the IR signal transmitter 10 is coupled to a transmitting coil 30 which is able to transmit electromagnetic waves with a wireless power.

In Block 902, the IR signal receiver 20 is activated when receiving the transmit electromagnetic waves with a wireless power.

In Block 903, the IRDA communication TX module 204 is activated after the IR signal receiver 20 is powered and is used for transmitting the IRDA communication signal with the at least one certain user information

In Block 904, the IRDA communication RX module 103 is used for receiving an IRDA communication signal with the at least one certain user information from the IRDA communication TX module 204.

In Block 905, when the at least one certain user information matches a stored user information inputted into the memory chip of the car entry, the correct user information will cause the doors 11 of the car entry to be unlocked.

The embodiments shown and described above are only examples. Many details are often found in the art such as the other features of a battery-free smart key entry process. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A car entry with infrared system comprising:
a car, comprising an infrared signal transmitter coupled to a transmitting coil for transmitting a electromagnetic waves and an infrared data association communication receiver module for receiving an infrared data association communication signal with at least one certain user information; and
a battery-free smart key, comprising an infrared signal receiver which is coupled to a receiving coil for receiving the electromagnetic waves and an infrared data association communication transmitter module for transmitting the infrared data association communication signal with the at least one certain user information.

2. The car entry with infrared system according to claim 1, wherein the car comprises a primary side controller coupling to the transmitting coil, the primary side controller is able of controlling the electromagnetic waves to the infrared signal received device.

3. The car entry with infrared system according to claim 2, wherein the car comprises an automotive battery for providing power to the primary side controller.

4. The car entry with infrared system according to claim 3, wherein the primary side controller comprises a first safety control, a first transmission coupling to the first safety control, a first authentication coupling to the first transmission and an indicator coupling to the authentication.

5. The car entry with infrared system according to claim 4, wherein the first safety control coupling to the first automotive battery for controlling the power distribution of the primary side controller.

6. The car entry with infrared system according to claim 4, wherein the first authentication is used to control the indicator to transmit the electromagnetic waves.

7. The car entry with infrared system according to claim 1, wherein the electromagnetic waves comprises a wireless power and a certification signal.

8. The car entry with infrared system according to claim 7, wherein the battery-free smart key comprises a secondary side controller coupling to the receiving coil.

9. The car entry with infrared system according to claim 8, wherein the secondary side controller comprises a second safety control, a second transmission coupled to the second safety control, a second authentication coupled to the second transmission and a DCDC convertor coupled to the second transmission.

10. The car entry with infrared system according to claim 9, wherein the second safety control is used for controlling the power distribution of the secondary side controller from the wireless power.

11. The car entry with infrared system according to claim 10, wherein the second authentication is used for certificating the certification signal from the infrared signal transmitter and through the DCDC convertor to control the infrared data association communication transmitter module.

12. A security entry with infrared system comprising:
an infrared signal transmitter, comprising a primary side controller and a transmitting coil coupled to the primary side controller for transmitting an electromagnetic waves, wherein the electromagnetic waves comprises a wireless power and a certification signal;
an infrared signal received device, comprising a secondary side controller and a receiving coil coupled to the secondary side controller for receiving the electromagnetic waves;
an infrared data association communication transmitter module, coupled to the secondary side controller for transmitting an infrared data association communication signal with at least one certain user information; and
an infrared data association communication receiver module, used for receiving the infrared data association communication signal from the infrared data association communication transmitter module.

13. The security entry with infrared system according to claim 12, wherein the primary side controller comprises a first safety control, a first transmission coupling to the first safety control, a first authentication coupling to the first transmission and an indicator coupling to the authentication.

14. The security entry with infrared system according to claim 13, wherein at least one battery is coupled to the first safety control for providing power.

15. The security entry with infrared system according to claim 12, wherein the secondary side controller comprises a second safety control, a second transmission coupled to the second safety control, a second authentication coupled to the second transmission and a DCDC coupled to the second transmission.

16. The security entry with infrared system according to claim 15, wherein the DCDC coupled to the infrared data association communication transmitter module.

17. A method of unlocking doors of a car entry, comprising:
transmitting electromagnetic waves with a wireless power from a transmitting coil of an infrared signal transmitter;
receiving the electromagnetic waves with a wireless power from the infrared signal transmitter by an infrared signal receiver;
activating an infrared data association communication transmitter module after the infrared signal receiver is powered through the wireless power, and transmitting the infrared data association communication signal with at least one certain user information through the infrared data association communication transmitter module;
receiving the infrared data association communication signal with the at least one certain user information from the infrared data association communication transmitter module; and
unlocking doors of the car entry when the at least one certain user information matches a stored user information inputted into a memory chip of the car entry.

18. The method of claim 18, wherein the electromagnetic waves further comprise a certificate signal used for an authentication to certificate the certification signal to control the infrared data association communication transmitter module.
